(19) United States
(12) Patent Application Publication
(10) Pub. No.: US 2026/0273994 A1
(43) Pub. Date: Sep. 17, 2026

(54) PAINT APPLICATOR CLEANING SYSTEM

(71) Applicant: UNIQUE MVP PTY LTD, Sandhurst (AU)

(72) Inventor: David Daly, Sandhurst (AU)

(21) Appl. No.: 18/851,160

(22) PCT Filed: Mar. 31, 2023
(86) PCT No.: PCT/AU2023/050250

§ 371 Date: Sep. 26, 2024

(51) Int. Cl. B44D 3/00; B05C 17/02

(52) U.S. Cl. CPC B44D 3/006; B05C 17/0245

(57) ABSTRACT

A variety of different application systems exist for applying paint and other similar coatings to a surface, such as a wall, roof and the like. Brushes have long been employed for such purposes whereby the brush is dipped in paint and the paint is applied to the surface in a brushing motion to apply an even coating of the paint over the surface. Roller applicators have also been popular as they comprise an absorbent outer surface that is capable of absorbing paint and releasing the paint to the surface as the roller application is rolled thereover. Such roller applicators have been particularly popular in painting large surface areas in short periods of time.

### RELATED APPLICATIONS

The present application claims priority from earlier filed Australian Provisional Patent Application No. 2022900832 filed 31 Mar. 2022, the entire contents of which are incorporated herein by reference.

### FIELD OF INVENTION

The present invention relates generally to a system for cleaning paint applicators, and in particular, a system for use in cleaning a paint roller applicator.

### BACKGROUND OF THE INVENTION

A variety of different application systems exist for applying paint and other similar coatings to a surface, such as a wall, roof and the like. Brushes have long been employed for such purposes whereby the brush is dipped in paint and the paint is applied to the surface in a brushing motion to apply an even coating of the paint over the surface. Roller applicators have also been popular as they comprise an absorbent outer surface that is capable of absorbing paint and releasing the paint to the surface as the roller application is rolled thereover. Such roller applicators have been particularly popular in painting large surface areas in short periods of time.

Due to their construction and their ability to absorb paint for release to the surface, after use, roller applicators often retain a large amount of paint, especially in the absorbent outer surface of the roller applicator. Failure to adequately clean the roller applicator immediately after use can result in the paint present on the roller hardening, which often compromises the useful life of the roller applicator and limits the ability for it to be reused. However, to perform adequate cleaning of paint roller applicators is difficult and time consuming due largely to the amount of paint absorbed by the applicator and the retention of the paint in the absorbent material.

Soaking roller applicators in water or a similar liquid will not generally release the paint from the absorbent material. Typically the roller applicator is positioned under a tap or the like to ensure that running water is incident on the surface of the absorbent material to assist in releasing the paint. In some instances it has been known to attach paint roller applicators to a handheld tool, such as a drill, and to clean, wash and dry the roller via high-speed spinning of the roller applicator. However, this process can damage the tool and/or the adaptor that interconnects the tool and the roller applicator, not least because when the roller applicator is covered in paint and/or water, the weight of the roller applicator is not evenly distributed about its longitudinal axis. As such, high-speed spinning of the roller applicator along its axis is often unbalanced. Moreover, such cleaning of paint roller applicators may not adequately clean the elongate opening extending through the roller applicator, which can also be coated in paint after use. Additionally, such cleaning process can be messy and result in paint and/or water inadvertently spraying onto the user and the adjacent environment.

Thus, there is a need to provide a cleaning system specifically dedicated for use with roller applicators to contain and clean the roller applicators in a simple and efficient manner.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a system for cleaning a used cylindrical paint roller applicator having an opening extending along a longitudinal axis thereof, comprising:
an adaptor configured to be connected to a tool for imparting rotary motion about an axis of rotation, the adaptor having a generally elongate body that is insertable into the opening of the roller applicator at a first end thereof so as to interconnect the roller applicator and the tool, whereby in use, actuation of the tool rotates the adaptor and thus spins the roller applicator about its longitudinal axis to effect removal of paint therefrom; and
a stabilising element configured to receive a distal end of the roller applicator, the stabilising element being adapted to maintain alignment of the longitudinal axis of the roller applicator with the axis of rotation of the tool during spinning of the roller applicator.

According to another aspect of the present invention, there is provided a system for use in cleaning a used cylindrical paint roller applicator having an opening extending along a longitudinal axis thereof, the kit comprising:
an adaptor configured to be connected to a tool for imparting rotary motion about an axis of rotation, the adaptor having a generally elongate body that is insertable into the opening of the roller applicator via a first end thereof so as to interconnect the roller applicator and the tool, whereby in use, actuation of the tool rotates the adaptor and thus spins the roller applicator about its longitudinal axis to effect removal of paint therefrom; and
a stabilising element configured to be inserted into the opening of the roller applicator via a second end thereof, the element being adapted to maintain alignment of the longitudinal axis of the roller applicator with the axis of rotation of the tool during spinning of the roller applicator.

In an embodiment of the system, the stabilising element comprises: a plug portion having a first diameter sized to be removably engageable with the roller applicator via insertion into an opening thereof; and a stabilising base having a second diameter that is larger than the first diameter.

In another embodiment of the system, the stabilising element comprises: a body portion configured to fit over the distal end of the roller applicator; and a stabilising base having a second diameter that is larger than the first diameter.

In embodiments of the system, an aperture extends along a longitudinal axis of the stabilising element such that, during spinning of the roller applicator in a cylindrical container of cleaning fluid, the cleaning fluid is drawn through the aperture and the opening of the roller applicator.

In another embodiment, the system further comprise a cylindrical container having an open end through which the roller applicator is insertable such that, in use, the roller applicator is substantially contained in the container and paint from the roller applicator is spun off onto an inner sidewall of the container.

The stabilising element may be incorporated within the cylindrical container to engage with the roller applicator when the roller applicator is inserted into the cylindrical container.

In embodiments of the ssytem, the inner diameter of the container is substantially similar to but larger than the second diameter of the stabilising base such that, in use, the stabilising element spins with the roller applicator and within the container, but is substantially constrained by the sidewall of the container against lateral movement away from the axis of rotation, thereby maintaining alignment of the roller applicator with the axis of rotation of the tool.

Embodiments of the system further comprise one or more additional cylindrical containers in which the roller applicator can be inserted and spun to effect washing and/or drying thereof.

Embodiments of the system further comprise a caddy for carrying the cylindrical containers.

Embodiments of the system further comprise the tool for spinning the roller applicator.

In embodiments of the system, a head of the tool is configured to substantially close the open end of the container(s) during spinning of the roller applicator therein.

According to another aspect of the present invention, there is provided a system for cleaning a used cylindrical paint roller applicator having an opening extending along a longitudinal axis thereof, the system comprising:
a tool for imparting rotary motion about an axis of rotation;
an adaptor configured to be connected to the tool and having a generally elongate body that is insertable into the opening of the roller applicator via a first end thereof so as to interconnect the roller applicator and the tool, whereby in use, actuation of the tool rotates the adaptor and thus spins the roller applicator about its longitudinal axis to effect removal of paint therefrom;
a stabilising element configured to be mounted to a distal end of the roller applicator via a second end thereof, the stabilising element being adapted to maintain alignment of the longitudinal axis of the roller applicator with the axis of rotation of the tool during spinning of the roller applicator ; and
one or more cylindrical containers having an open end through which the roller applicator is insertable such that, in use, the roller applicator is substantially contained in the or each container during spinning of the roller applicator.

According to a third aspect of the present invention, there is provided a method of cleaning a used cylindrical paint roller applicator using a system according to a second aspect of the present invention, the method comprising:
assembling the tool, adaptor, roller applicator and stabilising element together;
inserting at least the stabilising element and roller applicator of the assembly into a first container that is substantially empty; and
actuating the tool so as to spin the roller applicator to effect removal of paint therefrom.

Embodiments of the method further comprise:
after spinning in the first container, inserting at least the roller applicator of the assembly into a second container containing a cleaning fluid; and
actuating the tool so as to spin the roller applicator to effect washing of the roller applicator in the cleaning fluid.

Embodiments of the method further comprise:
after washing of the roller applicator in the cleaning fluid, inserting at least the roller applicator of the assembly into a third container that is substantially empty; and
actuating the tool so as to spin the roller applicator to effect drying thereof.

It will be appreciated that the order in which the cleaning, washing and/or drying steps are carried out can vary to suit the user and application. For example, the first step may involve spinning the paint-covered roller applicator in a container filled with water (instead of an empty container), such that paint removed from the roller applicator can be tipped out from the container along with the water, rather than have the removed paint coat the inside wall of the container. Next, the roller applicator may be immersed in another container filled with water for a second washing or cleaning of the roller applicator, before the roller applicator is dried in an empty container. In other words, the cleaning, washing and/or drying steps can vary in order and be repeated as necessary based on the needs of the user.

### BRIEF DESCRIPTION OF THE DRAWINGS

The invention may be better understood from the following non-limiting description of preferred embodiments, in which:

FIG. 1 is a side perspective view of a paint roller applicator, a first end of which is interconnected to a tool via an adaptor, a second end of which is fitted with a stabilising element, the adaptor and stabilising element forming part of a kit according to embodiments of the present invention for use in cleaning a used cylindrical paint roller cover;

FIG. 2 is a top perspective view of the tool and adaptor of FIG. 1;

FIG. 3 is a top perspective view of the stabilising element of FIG. 1;

FIG. 4 is a top view of a cylindrical container in which the paint roller applicator of FIG. 1 is inserted;

FIG. 5 is a front view of an experimental system set up to show spinning of a paint roller applicator within a transparent cylindrical container containing water;

FIG. 6 is a partially disassembled view of an example system for cleaning paint roller applicators;

FIG. 7A and FIG. 7B depict alternative embodiments of the stabilising element mounted to the roller applicator in accordance with another embodiment of the present invention; and

FIG. 8A-8D depict alternative embodiments of the stabilising elements incorporated within the cleaning containers in accordance with another embodiment of the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to its application for cleaning a conventional paint roller applicator for applying paint to a surface. However, it will be appreciated that the system of the present invention could be readily adapted to clean any variety of similar products of a variety of different materials, other than paint, as will be appreciated by those skilled in the art.

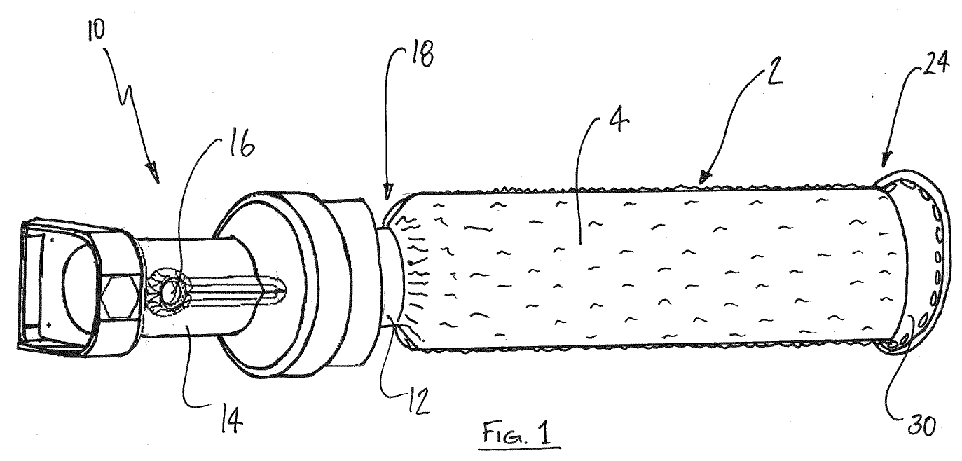

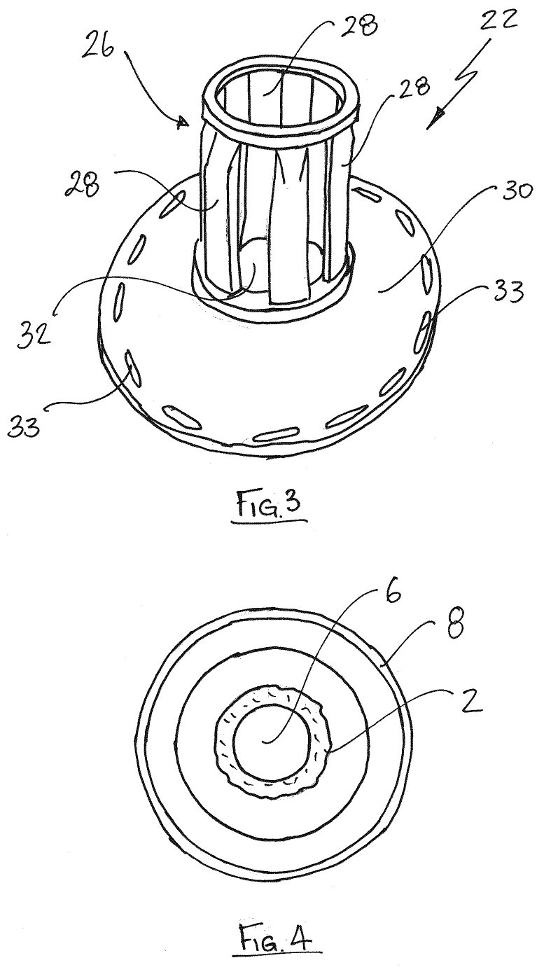

FIG. 1 shows a paint roller applicator 2 fitted for cleaning, washing and/or drying with an embodiment of the cleaning system of the present invention. The roller applicator 2 has a generally cylindrical body 4 having an opening 6 (see FIG. 4) extending along a longitudinal axis thereof. The external surface of the cylindrical body 4 is typically covered with an absorbent material for absorbing paint and for releasing paint to the surface being painted as the roller applicator is rolled across the surface, as is well known in the art.

As is shown in FIG. 1, a tool 10 is attachable to one end of the roller applicator 2 to effect cleaning of the roller applicator 2 after use. The tool 10 is configured to impart rotary motion about an axis of rotation. The tool 10 has a handle portion 14 that is configured to be gripped by a user to rotate the roller applicator 2 for cleaning. The tool 10 is powered by way of a battery, or may be mains powered, and a button 16 is provided to control the tool 10 for use.

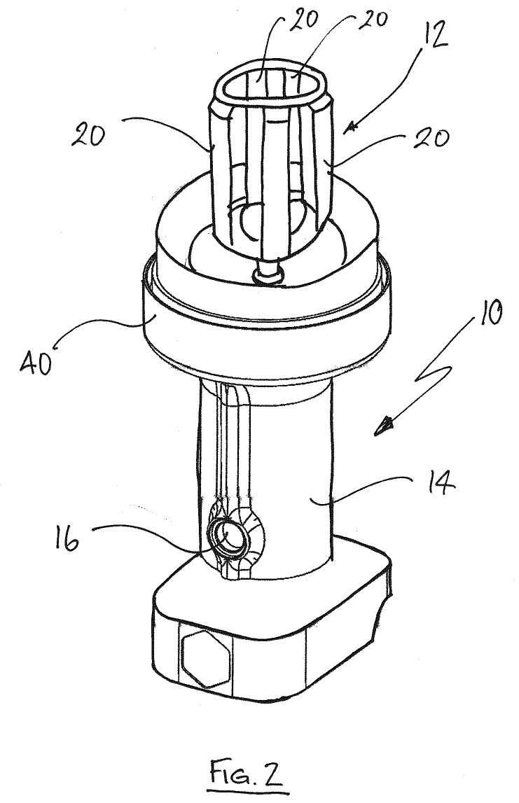

The tool 10 is configured to engage the roller applicator 2 via an adaptor 12, which is shown more clearly in FIG. 2. The adaptor 12 is mounted to a free end of the tool 10 to engage with an end of the roller applicator 2 such that actuation of the tool 10 causes the roller applicator 2 to spin about its longitudinal axis at a desired speed. The tool 10 may also be manually actuated (e.g., a hand-cranked tool) to impart rotational motion to the roller applicator 2.

Referring to FIG. 2, the adaptor 12 for interconnecting the tool 10 and the roller applicator 2 is shown in detail. The adaptor 12 comprises a substantially hollow and elongate cylindrical body, a first end of which is engageable with the tool 10 such that actuation of the tool 10 drives rotation of the adaptor 12 about its longitudinal axis.

The cylindrical body of the adaptor 12 is configured to be inserted into the opening 6 formed in an end of the roller applicator 2. In the depicted embodiment, the adaptor 12 may be formed from a substantially resilient material which enables a secure yet detachable friction fit with the opening 6 in the end of the roller applicator 2. In this regard, the outer diameter of the cylindrical body of the adaptor 12 may be equal to or slightly larger than the inner diameter of the opening 6 extending through the roller applicator 2 such that in urging the adaptor 12 into the opening 6 of the roller applicator 2, the adaptor 12 is compressed radially inwardly by the inner wall defining the opening 6 of the roller applicator 2. This compression of the cylindrical body of the adaptor 12 thus biases the resilient adaptor 12 to expand outwardly, whereby the body of the adaptor 12 urges against the inner cylindrical wall defining the opening 6 of the roller applicator 2, thereby retaining the roller applicator 2 to the adaptor 12. As such, in use, actuation of the tool 10 effects rotation of the adaptor 12 and thus the roller applicator 2 engaged therewith.

In the depicted embodiment, the elongate body of the adaptor 12 is defined by a series of longitudinally extending wall elements 20 arranged circumferentially so as to define the cylindrical body of the adaptor 12. Each wall element 20 is generally equispaced from adjacent wall elements 20. The wall elements 20 are configured to resiliently deflect or flex upon insertion of the adaptor 12 into the opening 6 of the roller applicator 2 to facilitate the friction fit therewith.

It will be appreciated that the manner in which the adaptor 12 is configure to engage with the opening 6 of the roller applicator 2 may vary, wherein the adapter 12 may have a first portion that is engageable with the tool 10 and a second portion that is engageable with the end of the roller applicator 2.

Referring to FIG. 1, when the roller applicator 2 is mounted to the tool 10, the distal end of the roller applicator 2 has a stabilising element 22 mounted therein. The stabilising element 22 is insertable into the opening 6 of the roller applicator 2 at the distal end 24 so as to assist in maintaining alignment of the roller applicator 2 during cleaning, as will be discussed in more detail below.

The stabilising element 22 may also be referred to as a mandrel, and is shown in isolation in FIG. 3. The mandrel 22 has a plug portion 26 configured to be inserted into the opening 6 of the roller applicator 2. To this end, the plug portion 26 comprises a generally cylindrical body having an outer diameter that is substantially equal or greater than the inner diameter of the opening 6 to form an interference fit within the opening 6 of the roller applicator 2, in much the same manner as the above described adaptor 12. To this end, the plug portion 26 of the stabalising element 22 may also comprise a series of longitudinally extending and equispaced wall elements 28 arranged circumferentially to define the cylindrical form of the plug portion 26 of the mandrel 22. As will be appreciated, the plug portion of the mandrel can take on many other forms that are removably insertable into and engageable with the opening 6 of the roller applicator 2, as will be appreciated by those skilled in the art. For example, rather than the plug portion having a generally cylindrical body, the body could be tapered or frustoconical such that it can be inserted into roller applicators 2 whose longitudinal openings 6 span a range of different diameters.

The mandrel 22 also has a stabilising base 30 having a generally circular profile. An elongate opening 32 extends through both the circular base 30 and the plug portion 26 of the mandrel 22. The circular base 30 has a diameter that is larger than that of the plug portion 26. Importantly, the diameter of the circular base 30 is configured to be substantially similar, or only slightly smaller than that of the inner diameter of a cleaning container 8, as will be described in more detail below.

Referring to FIG. 5, the cleaning system of the present invention is depicted in use. In this arrangement, the roller applicator 2 is mounted to the end of the tool 10 and is positioned inside a cleaning container 8 containing a cleaning fluid, such as water. The stabilising element 22 is mounted to the distal end of the roller applicator 2, and functions to work together with the internal walls of the cylindrical container 8, to ensure that during spinning of the roller applicator 2 under action of the tool 10, the longitudinal axis of the roller applicator 2 remains substantially aligned with the axis of rotation of the tool 10. In this way, even if the weight distribution of the roller applicator 2 is not even or well-balanced about its longitudinal axis (which can be the case if the roller applicator 2 is coated in paint and/or drenched in water), the stabilising element 22 helps facilitate spinning of the roller applicator 2 about the intended rotational axis of the tool 10.

In use, the circular base 30 of the mandrel 22 is configured to sit within the cylindrical container 8 such that the mandrel 22 can spin freely about its longitudinal axis. Since the diameter of the circular base 30 is substantially similar to the inner diameter of the container 8, the inner sidewall of the container 8 constrains the mandrel 22 against lateral movement within the container 8. In this regard, the diameter of the stabilising base 30 of the mandrel 22 and the inner diameter of the container 8 are correspondingly sized such that the mandrel 22, when inserted into the container 8, can spin freely about its longitudinal axis, but is substantially inhibited against lateral movement. As such, with the plug portion 26 of the mandrel 22 engaged with the roller applicator 2, when the mandrel 22 and roller applicator 2 are both inserted into the container 8, the mandrel 22 allows the roller applicator 2 to spin freely within the container 8 along the rotational axis of the tool 10, but inhibits lateral movement of the roller applicator 2 relative to the rotational axis of the tool 10. In this way, the mandrel 22 maintains alignment of the longitudinal axis of the roller applicator 2 with the axis of rotation of the tool 10 during spinning of the roller applicator 2 within the container 8 irrespective of whether the container 8 is filled with a cleaning fluid or is empty.

In the depicted embodiment, the generally circular base 30 of the mandrel 22 is formed with a plurality of spaced apart apertures 33, each being inwardly offset from the outer circumference of the circular base 30. Fluid can readily flow through the apertures 33 and the central elongate opening 32 so as to facilitate insertion of the mandrel 22 into a container 8 of cleaning fluid and withdrawal therefrom. It will be appreciated that the base 30 can have other forms and features to facilitate insertion of the mandrel into a container 8 of water and withdrawal therefrom. For example, in one embodiment, the base 30 could have a generally circular profile, wherein the perimeter of the base 30 has a wave-like or undulating form such that fluid can pass through the valley of each undulation.

FIG. 5 depicts the cleaning system in use, wherein the roller applicator 2 is spun within a container 8 filled with water. As is clearly seen, the inner diameter of the container 8 is slightly larger than the outer diameter of the roller applicator 2, such that during spinning of the roller applicator 2 in a cleaning fluid such as water, a vortex 34 is generated in the cleaning fluid which can travel through the elongate opening 32 of the mandrel 22 and the opening 6 of the roller applicator 2 so as to promote cleaning of the inner wall defining the elongate opening 6 of the roller applicator 2.

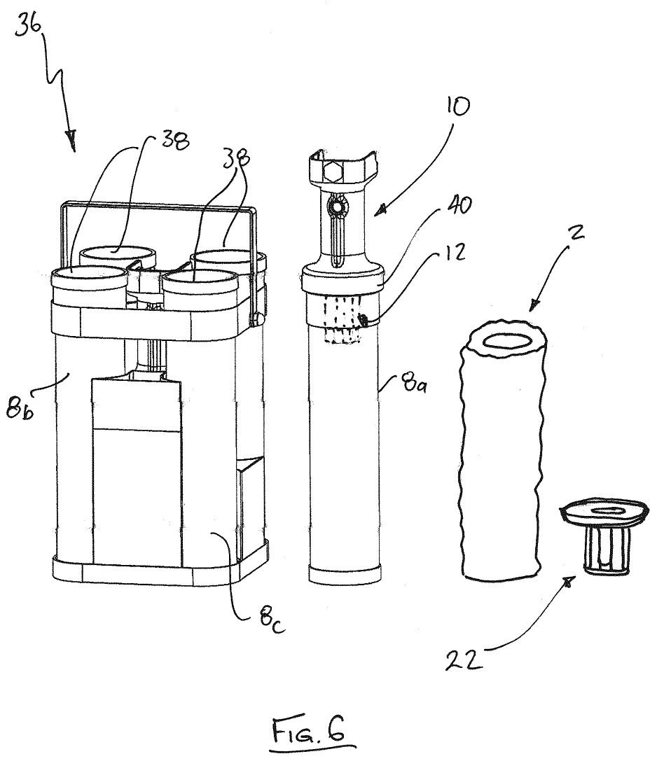

Whilst the stabilising element or mandrel 22 has been described above in relation to an element that fits into an opening 6 formed in the distal end 24 of the roller applicator 2, in another embodiment as shown in FIGS. 7A and 7B, the stabilising element 22 may be mounted over the distal end 24 of the roller applicator 2. In this arrangement, the stabilising element 22 may be in the form of a ring member 23 having a central opening shaped to snugly fit over the distal end 24 of the roller applicator 2. The ring member 23 may have rib members 25 extending therefrom so as to extend longitudinally over the surface of the roller applicator 2, as shown. In the embodiments depicted in FIG. 7A and FIG. 7B, rib members 25 are shown extending from opposing sides of the ring member 23, and are configured to grip the surface of the roller applicator 2 to assist in locating the stabilising element 22 on the roller applicator 2. In this regard, the rib members 23 may have a degree of resilience such that they are biased into contact with the surface of the roller applicator to aid in locating the ring member in position, but the bias can be easily overcome to slide the ring member 23 off the end of the roller applicator 2, when not required.

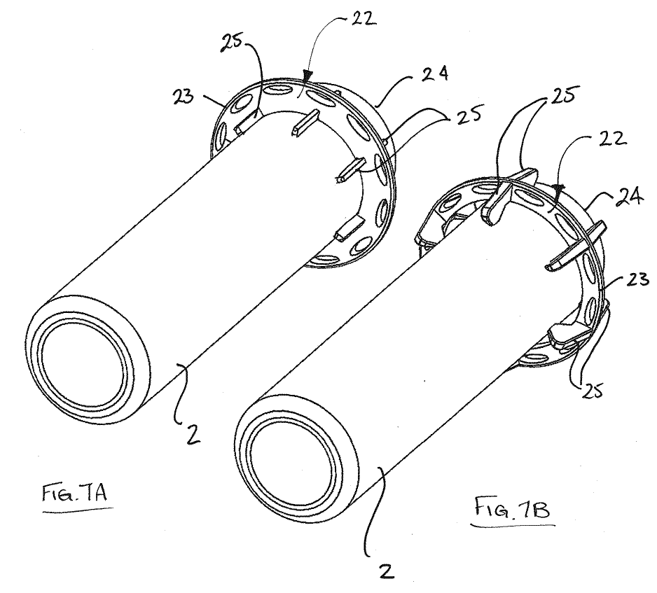

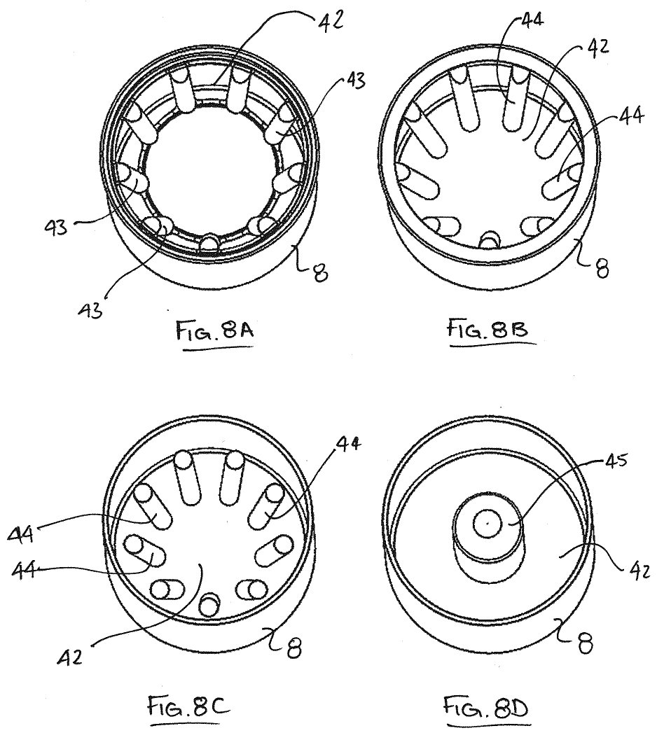

In an alternative embodiment of the present invention, the stabilising element 22 may be incorporated within the cylindrical containers 8 in the manner as depicted in FIG. 8A-8D.

This is achieved by the internal cavity of the containers 8 being configured to interact with the roller applicator 2 when inserted therein for cleaning, so as to stabilise the roller applicator when rotating under action of the rotary tool 10. In FIG. 8A, a central insert 42 is provided within the container 8 which has longitudinally extending rib members 43 arranged around the inner periphery of the container 8 to extend along the walls of the container 8, as shown. In this arrangement, when the roller applicator 2 is inserted into the container 8 for cleaning, the rib members 43 function to contact the roller applicator 2 to retain it in a central and stable position within the container 8 as it rotates under speed.

FIG. 8B depicts a similar arrangement whereby the insert 42 has a plurality of stem members 44 extending in a divergent manner from a base of the insert 42 to the opening of the container 8. The stem members 44 may be formed from a semi-rigid plastic material or a rubber so as to have a degree of resilience to bend upon contact with the roller applicator to contact the surface of the roller applicator 2 to stabilise the roller applicator 2 under rotation. FIG. 8C depicts a similar arrangement whereby the stem members are located remote from the walls of the container 8, in a similar divergent manner. The arrangement of FIGS. 8A and 8B allow for variable diameter roller applicators due to the divergent nature of the stem members. In the arrangement of FIG. 8D, the insert 42 has a central plug member 45 that is configured to be received in the opening 6 formed in the distal end 24 of the roller applicator so as to stabilise the roller applicator when rotated under speed for cleaning, in accordance with the present invention. It will be appreciated that the manner in which the cylinders 8 may be configured to receive and stabilise the roller applicator during cleaning may vary as will be appreciated by those skilled in the art.

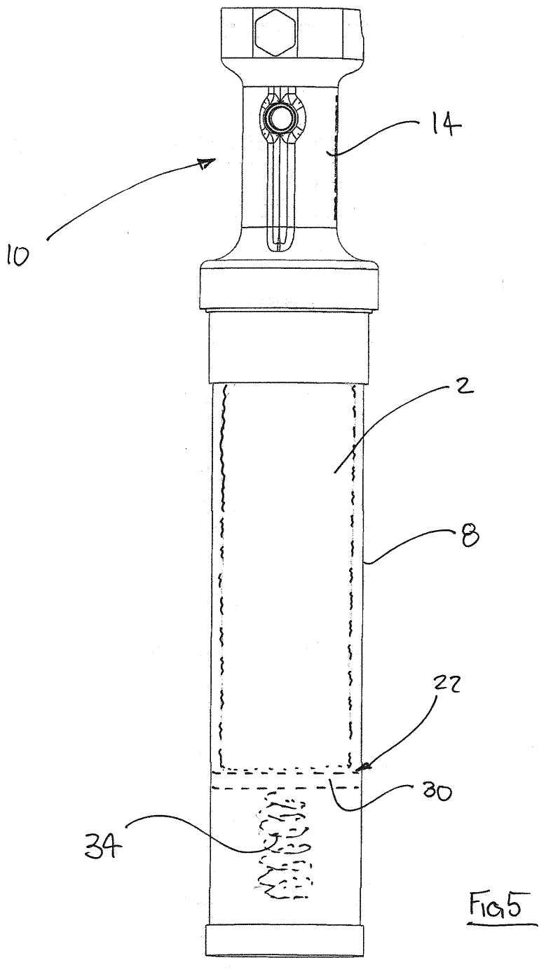

Referring to FIG. 6, a caddy 36 is shown, which is configured to carry a number of cylindrical containers 8 for use in cleaning one or more roller applicators 2. In this regard, to clean a used roller applicator 2, the roller applicator 2 can be inserted into in a first container 8a that is empty, and caused to spin under action of the tool 10. This spinning action of the roller applicator 2 will cause fee paint present in the absorbent surface of the roller applicator 2 to be forced from the roller applicator against the surface of the first container 8a, to be collected in the base portion of the first container 8a. The roller applicator 2, can be inserted into a second container 8b containing a cleaning fluid, such as water, and caused to spin under action of the tool 10. Such spinning of the roller applicator 2 in the fluid will generate agitation in the surfaces of the roller applicator 2 to effect washing of the roller applicator 2 and further removal of paint present therein. Following the washing step, roller applicator 2 can then be inserted into a third container 8c that is substantially empty to effect drying of the roller applicator 2. In this regard, once inserted, the roller applicator 2 can be further caused to spin under action of the tool 10 to facilitate removal of any water and entrained paint from the roller applicator 2. This process can be repeated or varied in order as required via the same or additional containers 8 to clean, wash and dry the roller applicator 2 as needed. In one embodiment, the caddy 36 may function as a drip tray to catch any fluids that might leak or drip from the containers 8.

It is envisaged that the containers 8 may be closable to facilitate storage of water and/or roller applicators 2 therein during transportation. For example, in FIG. 6, the open end of each container 8 may have an external thread that is configured to screwingly receive a respective cap 38 for closing the containers 8. It will be appreciated that other commonly known ways of closing containers may also be employed, such as snap-lock lids and the like, as will be appreciated by those skilled in the art.

To minimise mess, a head region 40 of the tool 10 adjacent to where the adaptor 12 is fitted may comprise a foam or rubber seal which, in use, is configured to be urged downwardly against an upper lip of a container 8. In this way, the tool 10 acts to substantially seal the open end of the container 8 such that during cleaning of the roller applicator 2, paint or moisture that is spun off from the roller applicator 2 is substantially if not completely contained within the container 8. It will be appreciated that the head region 40 of the tool 10 may also have an internal thread that threadingly engages with the opening of the containers 8 to form an enclosed cleaning space with the containers 8 to minimise spillage of fluid therefrom during use.

The present patent specification describes different components which can be used to clean, wash and/or dry a paint roller applicator. In one embodiment, the system could simply comprise the adaptor 12 and the stabilising element 22. In this case, a user could provide their own tool (such as a power drill) for use as the tool for imparting rotary motion, and provide their own cylindrical container(s) in which the roller applicator 2 can be spun. It will be appreciated that, the system can further include any one or more of: one or more cylindrical containers; and a tool for imparting rotary motion.

Many modifications of the above embodiments will be apparent to those skilled in the art without departing from the scope of the present invention. For example, while the stabilising element 22 has been depicted and described as a separate element, it could also form part of the container 8. In one example, an interior base end of the container 8 may comprise an upwardly extending plug portion that can be inserted into the opening 6 of the roller applicator 2. In this way, the stabilising element could comprise a plug-like element that forms part of the container itself that is insertable into the opening 6 of the roller applicator 2 to align rotation thereof with the rotational axis of the tool 10. In this embodiment, the system would comprise both the adaptor 12 and a container 8 that is configured with the stabilising element therein.

The presently disclosed subject matter can of course be adapted to suit roller applicators with a range of different lengths.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the system uppermost.

It will be appreciated by those skilled in the art that many modifications and variations may be made to the methods of the invention described herein without departing from the spirit and scope of the invention.

The claims defining the invention are as follows:

1. A system for cleaning a used cylindrical paint roller applicator having an opening extending along a longitudinal axis thereof, comprising:
an adaptor configured to be connected to a tool for imparting rotary motion about an axis of rotation, the adaptor having a generally elongate body that is insertable into the opening of the roller applicator at a first end thereof so as to interconnect the roller applicator and the tool, whereby in use, actuation of the tool rotates the adaptor and thus spins the roller applicator about its longitudinal axis to effect removal of paint therefrom; and
a stabilising element configured to receive a distal end of the roller applicator, the stabilising element being adapted to maintain alignment of the longitudinal axis of the roller applicator with the axis of rotation of the tool during spinning of the roller applicator.

2. The system of claim 1, wherein the stabilising element comprises:
a plug portion having a first diameter sized to be removably engageable with the roller applicator via insertion into an opening thereof formed in the distal end thereof; and
a stabilising base having a second diameter that is larger than the first diameter.

3. The system of claim 2, wherein an aperture extends along a longitudinal axis of the stabilising element such that, during spinning of the roller applicator in a cylindrical container of cleaning fluid, the cleaning fluid is drawn through the aperture and the opening of the roller applicator.

4. The system of any one of the preceding claims, further comprising a cylindrical container having an open end through which the roller applicator is received such that the roller applicator is substantially contained in the container and paint from the roller applicator is spun off onto an inner sidewall of the container.

5. The system of claim 4 as appended to claim 1, wherein the stabilising element is incorporated into the cylindrical container.

6. The system of claim 4 as appended to claim 2 or 3, wherein the inner diameter of the container is substantially similar to but larger than the second diameter of the stabilising base such that, in use, the stabilising element spins with the roller applicator and within the container, but is substantially constrained by the sidewall of the container against lateral movement away from the axis of rotation, thereby maintaining alignment of the roller applicator with the axis of rotation of the tool.

7. The system of claim 6, further comprising one or more additional cylindrical containers in which the roller applicator can be inserted and spun to effect washing and/or drying thereof.

8. The system of claim 7, further comprising a caddy for carrying the cylindrical containers.

9. The system of any one of the preceding claims, further comprising the tool for spinning the roller applicator.

10. The system of claim 9 as appended to any one of claims 4 to 7, wherein a head of the tool is configured to substantially close the open end of the container(s) during spinning of the roller applicator therein.

11. A system for cleaning a used cylindrical paint roller applicator having an opening extending along a longitudinal axis thereof, the system comprising:
a tool for imparting rotary motion about an axis of rotation;
an adaptor configured to be connected to the tool and having a generally elongate body that is insertable into the opening of the roller applicator via a first end thereof so as to interconnect the roller applicator and the tool, whereby in use, actuation of the tool rotates the adaptor and thus spins the roller applicator about its longitudinal axis to effect removal of paint therefrom;
a stabilising element mounted to a distal end of the roller applicator, the stabilising element being adapted to maintain alignment of the longitudinal axis of the roller applicator with the axis of rotation of the tool during spinning of the roller applicator ; and
one or more cylindrical containers having an open end through which the roller applicator is insertable such that, in use, the roller applicator is substantially contained in the or each container during spinning of the roller applicator.

12. A method of cleaning a used cylindrical paint roller applicator using a system of claim 11, the method comprising:
assembling the tool, adaptor, roller applicator and stabilising element together;
inserting at least the stabilising element and roller applicator of the assembly into a first container that is substantially empty; and
actuating the tool so as to spin the roller applicator to effect removal of paint therefrom.

13. The method of claim 12, further comprising:
after spinning in the first container, inserting at least the roller applicator of the assembly into a second container containing a cleaning fluid; and
actuating the tool so as to spin the roller applicator to effect washing of the roller applicator in the cleaning fluid.

14. The method of claim 13, further comprising:
after washing of the roller applicator in the cleaning fluid, inserting at least the roller applicator of the assembly into a third container that is substantially empty; and
actuating the tool so as to spin the roller applicator to effect drying thereof.
